(19) United States
(12) Patent Application Publication
(10) Pub. No.: US 2003/0208545 A1
(43) Pub. Date: Nov. 6, 2003

(54) Instant message communication system for providing notification of one or more events and method therefor

(76) Inventors: Eric Thomas Eaton, Lake Worth, FL (US); Carlos Sixto Baradello, Hallandale, FL (US)

Correspondence Address: Randi L. Dulaney, Motorola, Inc., Law Department, 8000 West Sunrise Boulevard, Fort Lauderdale, FL, 33322, US

(21) Appl. No.: 10/137,022

(22) Filed: May 1, 2002

(51) Int. Cl. G06F 15/16

(52) U.S. Cl. 709/206

(57) ABSTRACT

An instant message communication system (100) provides notification of one or more events (180). The instant message communication system (100) includes a server (110). The server (110) includes a server memory (160) for storing a plurality of screen names (280). Each of the plurality of screen names (280) represents one or more events (180). The server (110) further includes a server processor (150) coupled to the server memory (160), wherein the server processor (150) is programmed to activate at least one of the plurality of screen names (280) in response to the presence of one or more events (180) represented by at least one of the plurality of screen names (280).

### BACKGROUND OF THE INVENTION

1. Field of the Invention

This invention relates in general to instant message communication systems and in particular to instant message communication systems incorporating capabilities to provide notification of an event to instant message devices operating within the instant message communication system.

2. Description of the Related Art

Television viewing is growing in popularity worldwide. To meet the needs of its viewers, nationwide, regional and local television programming covering a variety of topics is available on a multitude of television channels. Some channels are topic-specific, for example sports or health, while others program an assortment of topics. Today, a viewer either “surfs” the channels during a time when he/she is available to watch a show; or previews a schedule of shows and topics periodically to know when an event of interest is airing.

To meet the needs of its viewers who are not able to always be in front of their television, many networks are now providing alternative viewing avenues. For example, access to sporting events is available through online website sources including sports news, information, listings, real-time sports score tracking, games and special features about sports programming. Further sports radio programs provide spectators with live action through audio channels. Viewer interaction with others viewing a particular sporting event is currently available through the Internet using their personal computers.

Television programmers have found the proliferation of wireless devices as a particularly good avenue for providing programming information to viewers. One example of useful technology is U.S. Pat. No. 6,167,235, issued Dec. 26, 2000 to Sibecas et al. and titled “Method And Apparatus For Providing Additional Information To A Selective Call Device About A Broadcast” which is assigned to the assignee of the present invention, and which is incorporated by reference herein. This invention describes a technique in a selective call communication system and in a broadcast communication system to provide additional information about a broadcast to a selective call device. The transfer of connection information (e.g. URL (Uniform Resource Locator), Information service address and sub-address) is covered by the described invention.

One drawback of both the traditional viewing avenues and the newly created viewing avenues is the need for the viewers to manually be informed of the programming schedules. Viewers miss special events and other special programming when not informed of their occurrence.

With the proliferation of the Internet, the way people communicate is changing. Electronic communication such as electronic mail (email), and real time electronic messaging (e.g. instant messaging and chat messaging) is quickly replacing traditional telephonic communication and handwritten letters. Instant messaging allows the simultaneous access to a message or a plurality of messages by multiple account users, with each account user capable of inputting a message or a plurality of messages to an instant messaging session. Each inputted message is relayed to instant messaging clients operating on instant messaging devices (such as computers) of the other account users who have chosen to participate in that instant messaging session. The other session participants can respond with their own messages, which are likewise relayed to all the participating devices. These messages are typically text messages that are delivered to the intended recipient(s) of the message in a real time manner. However, these messages may be in a variety of different media formats or combinations thereof such as audio, animation, video, images, etc. A session history of the messages received and transmitted by all participants involved in the messaging session is typically maintained on the individual participants' devices and typically presented on the screen of the respective device in the form of a scrolling dialog. This text history constitutes one of the attributes of the look and feel of the real time electronic messaging experience.

Each instant messaging session can have various types of session attributes such as session type, session connection info, participants, filter settings, colors, relative font sizes, etc. The account user can also have various types of preferences such as colors, relative font sizes, buddy lists, nicknames, and parental control settings. These are only a few examples of the attributes and preferences that can affect an instant messaging session.

In order to utilize instant messaging, an instant message device is pre-configured with, or the user installs, application client software distributed by a particular service provider. The client software connects to a server for communication. To access the server, via a logon procedure, the client sends the routing information (e.g. IP address and number of the port assigned to the client, mobile phone number) of the instant message device being used, the account user's username, the account user's password, and the account user's current availability setting to the server. The server temporarily stores the routing and availability information for the account user's device. In response to the account user's login information (username and password), the server provides the messaging client with the account user's contact list. The server then determines the presence and availability of the account users in that contact list. If the server finds any of the contacts logged in (i.e. presence setting is online), it sends a message back to the messaging client on the instant message device with the presence and availability information for that account user. The server also sends the account user's presence and availability information to the people that have the account user in their contact list. The account user can click on the name of a person in his/her contact list who is online, and a window is created in which the account user can enter a message. The account user enters a message and clicks “send” to communicate with that person. The other person gets the message and can respond. Messages between account users can be addressed directly to the account user's instant message device or can be addressed to the username and sent via the server.

When the messaging session is complete, the account users close the message window for that messaging session. When the account user signs off, his/her messaging client sends a message to the server to terminate the account user's participation in the plurality of sessions. The server then sends an update of the account user's presence and availability information to the people that have the account user in their contact list to indicate the account user has signed off. Finally, the server discards the routing and availability information for the account user's device. Currently, instant message communication is limited to person-to-person communication.

What is needed is the ability to deliver a notification to viewers about the presence and availability of an event of interest using instant message communication technology.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a block diagram of one embodiment of an instant message communication system in accordance with the present invention;

FIG. 2 illustrates a block diagram of one embodiment of a server memory for use within a server of the instant message communication system of FIG. 1 in accordance with the present invention;

FIG. 3 illustrates an electronic block diagram of one embodiment of an instant message device for use within the instant message communication system of FIG. 1 in accordance with the present invention;

FIG. 4 illustrates one embodiment of an instant message user interface for use within the instant message device of FIG. 3 in accordance with the present invention;

FIG. 5 illustrates one embodiment of an instant message for use within the instant message communication system of FIG. 1 in accordance with the present invention;

FIG. 6 illustrates a block diagram of an alternate embodiment of a server memory for use within a server of the instant message communication system of FIG. 1 in accordance with the present invention;

FIG. 7 illustrates an alternate embodiment of an instant message user interface for use within the instant message device of FIG. 3 in accordance with the present invention;

FIG. 8 illustrates an alternate embodiment of an instant message for use within the instant message communication system of FIG. 1 in accordance with the present invention;

FIG. 9 illustrates an alternate embodiment of an instant message communication system in accordance with the present invention;

FIG. 10 illustrates an electronic block diagram of a content server for use in the instant message communication system of FIG. 9 in accordance with the present invention; and

FIGS. 11-14 are flowcharts illustrating various embodiments of the operation of the instant message communication system of FIGS. 1 and 9 in accordance with the present invention.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

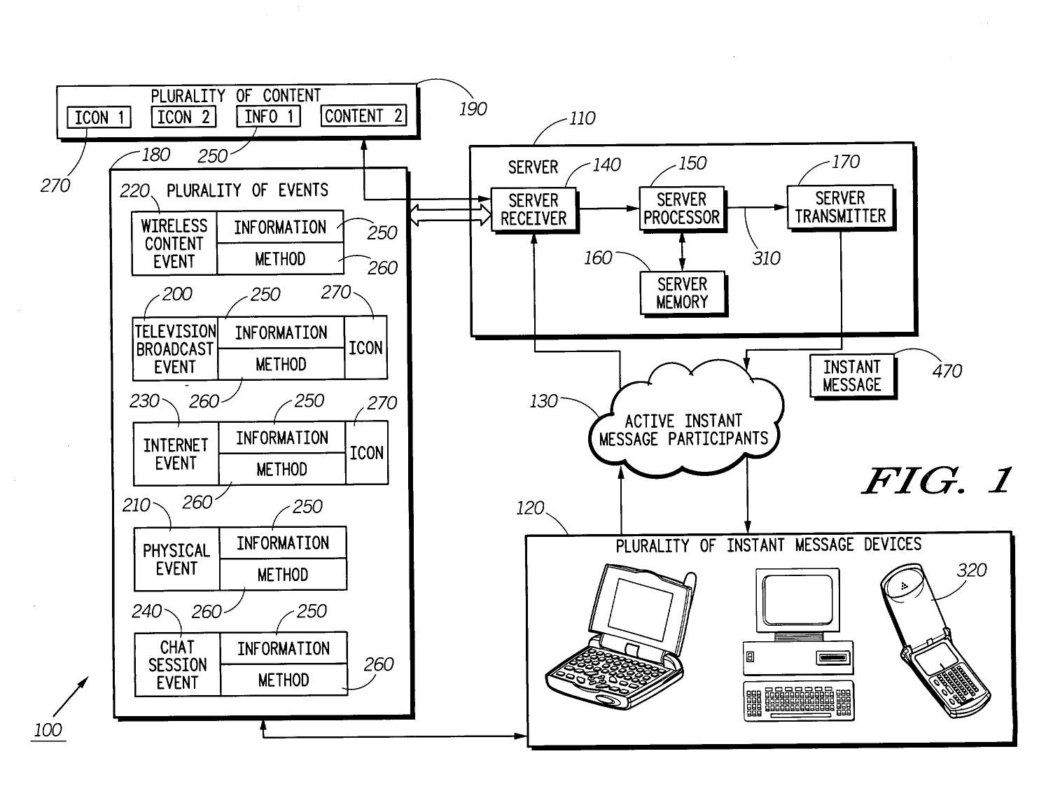

Referring to FIG. 1, an instant message communication system 100 in accordance with the present invention is illustrated. The instant message communication system 100 preferably includes a server 110 and a plurality of instant message devices 120 selectively communicating as active instant message participants 130.

The server 110 preferably includes a server receiver 140, a server processor 150, a server memory 160, and a server transmitter 170. In one embodiment of the present invention, the server receiver 140 functions by intercepting transmitted signals from a wireless communication system. It will be appreciated by one of ordinary skill in the art that the server receiver 140 can function by intercepting transmitted signals from any wireless radio frequency (RF) channel, for example, a one or two-way pager channel, a mobile cellular telephone channel, or a mobile radio channel. Similarly, it will be appreciated by one of ordinary skill in the art that the server receiver 140 can function by intercepting transmitted signals from other types of wireless communication channels such as infrared channels and Bluetooth channels. In another embodiment, the server receiver 140 functions by intercepting signals from a wired communication system, for example from a local area network (LAN) or a wide area network (WAN) or a combination of both. The server receiver 140 can operate by receiving signals from a network that uses a physical network such as ARCNET, Ethernet, Token-ring, Local Talk or other network media. The server receiver 140 can operate by receiving signals over a LAN that employs any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures. Further the server receiver 140 can operate by receiving signals over a WAN that uses a different physical network media such as X.25, Frame Relay, ISDN, Modem dial-up or other media to connect other computers or other local area networks. It will be appreciated by one of ordinary skill in the art that the server receiver 140 can operate using any combination of the communication systems mentioned herein or an equivalent.

Preferably, and in accordance with the present invention, the server receiver 140 is coupled to and receives information about a plurality of events 180. It will be appreciated by those of ordinary skill in the art that the plurality of events 180 can include, for example, physical events 210 such as sporting events, television or radio broadcast events 200, wireless content events 220, internet events 230, chat session events 240, or an equivalent. Each event can be separately designated within the instant message communications system 100, or alternatively can be grouped within one or more topics (not shown). For example, a general topic can be the National Football League (NFL) and all events relating to the NFL such as a live NFL game or a pay per view broadcasted NFL game can be grouped within the general topic. Preferably, each of the plurality of events has associated with it a plurality of event information 250, a method for event participation 260, one or more event icons 270, or an equivalent.

Preferably, and in accordance with the present invention, the server receiver 140 is further coupled to a plurality of content 190. The plurality of content 190, for example, can include one or more of the event icons 270 and/or one or more of the plurality of event information 250 associated with one or more of the plurality of events 180. The plurality of content 190, for example, can include weather, traffic, events, restaurants, shopping, services, sports, and the like.

Within the server 110, the server receiver 140 is coupled to the server processor 150. The server processor 150 utilizes conventional signal processing techniques for processing received signals from the server receiver 140. Preferably, the server processor 150 is similar to the MC68328 micro-controller manufactured by Motorola, Inc. of Schaumburg, Ill. It will be appreciated that other similar processors can be utilized for the server processor 150, and that additional processors of the same or alternative type can be added as required to handle the processing requirements of the server processor 150.

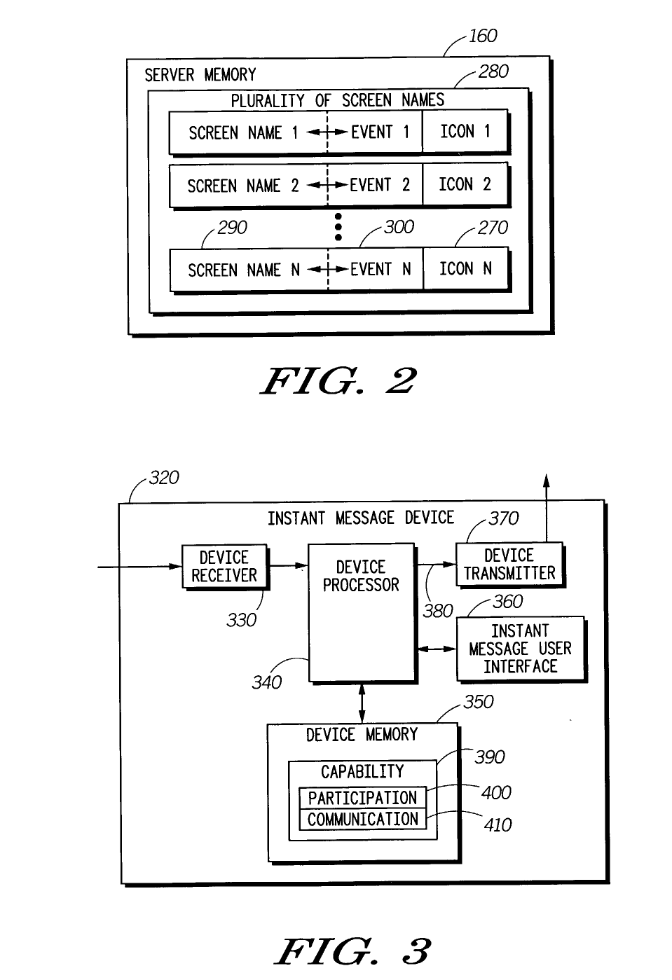

To perform the necessary functions of the server 110, the server processor 150 is coupled to the server memory 160, which preferably includes a random access memory (RAM), a read-only memory (ROM), an electrically erasable programmable read-only memory (EEPROM), and/or a magnetic storage memory (for example a hard drive). FIG. 2 illustrates one embodiment of the server memory 160 in accordance with the present invention. As illustrated, the server memory 160 preferably stores a plurality of screen names 280. Each screen name 290 of the plurality of screen names 280 represents one or more events such as an event 300 of the plurality of events 180. The screen name 290, the associated event 300, and optionally, one or more event icons 270 associated with the event 300 are stored within the server memory 160 for use in accordance with the present invention.

The server processor 150, in accordance with the present invention, is programmed to activate at least one of the plurality of screen names 280 such as the screen name 290 stored in the server memory 160 in response to the presence of one or more events such as the event 300 represented by the screen name 290. The screen name 290 thereafter functions as one of the active instant message participants 130 of the instant message communication system 100.

The server 110 can become aware of the presence of an event in a variety of techniques. For example, the event provider can originate an event notification. The server 110 receives the event notification via the server receiver 140. Alternatively, the event provider can send a schedule of events in advance. The server 110 receives the schedule of events via the server receiver 140 and can store the schedule of events in the server memory 160 (not shown) for later retrieval by the server processor 150. Alternatively, the server 110 can include one or more search engines (not shown) to identify the availability of one or more of the plurality of events 180.

The server processor 150, in accordance with the present invention, can further be programmed to activate at least one of the plurality of screen names 280 such as the screen name 290 stored in the server memory 160 in response to the presence of the plurality of event information 250 about one or more events such as the event 300 represented by the screen name 290. The screen name 290 thereafter functions as one of the active instant message participants 130 of the instant message communication system 100. Similarly, the server processor 150, in accordance with the present invention, can further be programmed to activate at least one of the plurality of screen names 280 such as the screen name 290 stored in the server memory 160 in response to the presence of the one or more event icons 270 associated with one or more events such as the event 300 represented by the screen name 290. The screen name 290 thereafter functions as one of the active instant message participants 130 of the instant message communication system 100.

The server transmitter 170 is coupled to and receives one or more command signals 310 from the server processor 150, and in response to a command signal, communicates instant messages as an active instant message participant within the instant message communication system 100. In one embodiment of the present invention, the server transmitter 170 functions by sending signals via a wireless communication system. It will be appreciated by one of ordinary skill in the art that the server transmitter 170 can function by sending signals via any wireless radio frequency (RF) channel, for example, a one or two-way pager channel, a mobile cellular telephone channel, or a mobile radio channel. Similarly, it will be appreciated by one of ordinary skill in the art that the server transmitter 170 can function by sending signals via other types of wireless communication channels such as infrared channels and Bluetooth channels. In another embodiment, the server transmitter 170 functions by sending signals via a wired communication system, for example from a local area network (LAN) or a wide area network (WAN) or a combination of both. The server transmitter 170 can operate by sending signals via a network that uses a physical network such as ARCNET, Ethernet, Token-ring, Local Talk or other network media. The server transmitter 170 can operate by sending signals over a LAN that employs any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures. Further the server transmitter 170 can operate by sending signals over a WAN that uses a different physical network media such as X.25, Frame Relay, ISDN, Modem dial-up or other media to connect other computers or other local area networks. It will be appreciated by one of ordinary skill in the art that the server transmitter 170 can operate using any combination of the communication systems mentioned herein or an equivalent.

As illustrated in FIG. 1, the instant message communication system 100 includes the plurality of instant message devices 120. The plurality of instant message devices 120 can include personal digital assistants, personal computers, interactive broadcast transceivers, and mobile communication devices, or an equivalent.

FIG. 3 illustrates an electronic block diagram of one embodiment of an instant message device 320 of the plurality of instant message devices 120 in accordance with the present invention. As illustrated, and in accordance with the present invention, the instant message device 320 includes a device receiver 330, a device processor 340, a device memory 350, an instant message user interface 360, and a device transmitter 370.

The device receiver 330 receives messages sent within the instant message communication system 100 such as event presence notification messages. It will be appreciated by those of ordinary skill in the art that the event presence notification messages can be received by the device receiver 330 from the server 110. Alternatively, the event presence notification messages can be received/detected directly by the device receiver 330 from the plurality of content 190 and/or the plurality of events 180. For example, the event presence notification message can be sent via a short range communication system causing the device receiver 330 to receive an event presence notification message when the instant message device 320 is locally present within a short range of one or more events.

In one embodiment of the present invention, the device receiver 330 functions by intercepting transmitted signals from a wireless communication system. It will be appreciated by one of ordinary skill in the art that the device receiver 330 can function by intercepting transmitted signals from any wireless radio frequency (RF) channel, for example, a one or two-way pager channel, a mobile cellular telephone channel, or a mobile radio channel. Similarly, it will be appreciated by one of ordinary skill in the art that the device receiver 330 can function by intercepting transmitted signals from other types of wireless communication channels such as infrared channels and Bluetooth channels. In another embodiment, the device receiver 330 functions by intercepting signals from a wired communication system, for example from a local area network (LAN) or a wide area network (WAN) or a combination of both. The device receiver 330 can operate by receiving signals from a network that uses a physical network such as ARCNET, Ethernet, Token-ring, Local Talk or other network media. The device receiver 330 can operate by receiving signals over a LAN that employs any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures. Further the device receiver 330 can operate by receiving signals over a WAN that uses a different physical network media such as X.25, Frame Relay, ISDN, Modem dial-up or other media to connect other computers or other local area networks. It will be appreciated by one of ordinary skill in the art that the device receiver 330 can operate using any combination of the communication systems mentioned herein or an equivalent.

The device receiver 330 is coupled to the device processor 340. The device processor 340 utilizes conventional signal processing techniques for processing received signals from the device receiver 330 including the event presence notification messages. Preferably, the device processor 340 is similar to the MC68328 micro-controller manufactured by Motorola, Inc. of Schaumburg, Ill. It will be appreciated that other similar processors can be utilized for the device processor 340, and that additional processors of the same or alternative type can be added as required to handle the processing requirements of the device processor 340.

To perform the necessary functions of the instant message device 320, the device processor 340 is coupled to the device memory 350, which preferably includes a random access memory (RAM), a read-only memory (ROM), an electrically erasable programmable read-only memory (EEPROM), and/or a magnetic storage memory (for example a hard drive). The device memory 350 preferably includes the storage of a plurality of device capabilities 390, including a plurality of participation capabilities 400 and a plurality of communication capabilities 410. The plurality of participation capabilities 400 can include, for example, the media supported (e.g. audio, video), device type, device protocol usage, device display, device battery life, device battery capacity or available power source, device processing power, device computing time power, and software applications. It will be appreciated by those of ordinary skill in the art that the plurality of participation capabilities 400, in accordance with the present invention, can be any combination of the capabilities mentioned herein or an equivalent. The plurality of communication capabilities 410 can include, for example, available modem speed, protocol support, wireless communication capability, wired communication capability, or an equivalent. The plurality of communication capabilities 410 can further include the communication capability of the current device user. It will be appreciated by those of ordinary skill in the art that the plurality of communication capabilities 410, in accordance with the present invention, can be any combination of the capabilities mentioned herein or an equivalent. Further, the device memory 350 preferably includes the storage of a plurality of topic screen names of interest 405 and/or a plurality of event screen names of interest 415.

The device transmitter 370 is coupled to and receives one or more command signals 380 from the device processor 340, and in response to a command signal, communicates as an active instant message participant within the instant message communication system 100. In one embodiment of the present invention, the device transmitter 370 functions by sending signals via a wireless communication system. It will be appreciated by one of ordinary skill in the art that the device transmitter 370 can function by sending signals via any wireless radio frequency (RF) channel, for example, a one or two-way pager channel, a mobile cellular telephone channel, or a mobile radio channel. Similarly, it will be appreciated by one of ordinary skill in the art that the device transmitter 370 can function by sending signals via other types of wireless communication channels such as infrared channels and Bluetooth channels. In another embodiment, the device transmitter 370 functions by sending signals via a wired communication system, for example from a local area network (LAN) or a wide area network (WAN) or a combination of both. The device transmitter 370 can operate by sending signals via a network that uses a physical network such as ARCNET, Ethernet, Token-ring, Local Talk or other network media. The device transmitter 370 can operate by sending signals over a LAN that employs any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures. Further the device transmitter 370 can operate by sending signals over a WAN that uses a different physical network media such as X.25, Frame Relay, ISDN, Modem dial-up or other media to connect other computers or other local area networks. It will be appreciated by one of ordinary skill in the art that the device transmitter 370 can operate using any combination of the communication systems mentioned herein or an equivalent.

Preferably, the instant message device 320 includes an instant message user interface 360. The instant message user interface 360, for example, can include a display, a keyboard, a button or series of buttons, a mouse, a pen or puck activated table, a trackball, an audio activated command recognition processor, or an equivalent, that allows a device user to view, enter and manipulate information.

Each device user can configure the instant message user interface 360 with one or more user preferences. The user preferences can include, for example, a list of identifiers, referred to conventionally as screen names, which represent people the device user communicates with. The device user is notified when anyone on his/her list of identifiers signs onto the instant message communication system 100 as an active instant message participant, and thus can become available for communicating (referred to conventionally as chatting). This list of identifiers is commonly called a buddy list. Typically there is some indication as to the status of each of the buddies on the buddy list. For example, in one system a light bulb is changed from dark to light beside the users that are available. In another system the buddy's screen name appears in a buddy window. These are all in an effort to inform the device user of the presence of a person for real time electronic communication.

FIG. 4 illustrates one embodiment of the instant message user interface 360 in accordance with the present invention. As illustrated, the instant message user interface 360 preferably includes information displayed regarding one or more events of interest 420. The device user can manually enter the one or more screen names for the one or more events of interest 420 into the instant message user interface 360. Alternatively, and in accordance with the present invention, the one or more screen names for the one or more events of interest 420 can be chosen from the plurality of screen names 280 stored in the server memory 160 of the server 110. For example, the server 110 can send a list of the plurality of screen names 280 and the device user can choose from this list. It will be appreciated by those of ordinary skill in the art that the instant message user interface 360 can further include one or more identifiers of people the device user is interested in communicating with (not shown) in accordance with the present invention. As illustrated in FIG. 4, for each event of interest, at least one of an event identifier 430, an event status 440, an event presence indicator 450, and/or an event availability indicator 460 can be displayed within the instant message user interface 360.

The event identifier 430 represents the event 300 of the plurality of events of interest 420. The event identifier 430, in accordance with the present invention, preferably is the screen name 290 associated with the event 300. The event identifier 430 can be programmed by the device user to be continuously present within the instant message user interface 360 of the instant message device 320. Alternatively, the event identifier 430 can be activated within the instant message user interface 360 in response to a physical event. It will be appreciated that the event identifier 430 can be activated within the instant message user interface 360 as described herein or an equivalent.

Each event identifier 430 preferably has an associated event status 440. The event status 440 provides visual and/or audible notification to the device user of the presence of the event 300. This is a flexible, simple and effective way to allow the device user to provision the instant message device 320, on a personal basis, for notification of events of interest to the device user. Preferably, the event status 440 changes in response to the notification from the server 110 of the presence of the event 300.

In one embodiment of the present invention, the event presence indicator 450 is associated with the event identifier 430 for the event 300. Preferably, the event presence indicator 450 changes in response to the notification from the server 110 of the presence of the event 300. The device user, in accordance with the present invention, can configure the level of interest for each screen name 290 and associated event 300. For example, the user could enter football, and receive all the football “presence” notifications that would include the all football teams and change the presence indicator 450 accordingly. Alternatively, the device user can choose one football team and receive only football events related to that chosen football team and change the presence indicator 450 accordingly. The user could further restrict the level of interest by entering football games only to limit the “presence” to an actual football game and change the presence indicator 450 accordingly.

In one embodiment of the present invention, the event availability indicator 460 is associated with the event identifier 430 for the event 300. Preferably, the event availability indicator 460 changes in response to the notification from the server 110 of the presence of the event 300 along with one or more other factors. For example, the event availability indicator 460 can change when the instant message device 320 includes the capability to participate in the event 300. Referring to FIG. 3, the device processor 340, in response to receiving a notification of the presence of an event, retrieves the plurality of participation capabilities 400 from the device memory 350. When the plurality of participation capabilities 400 provide the capability for the instant message device 320 to participate in the event 300, the device processor 340 sends a command to the instant message user interface 360 to change the event availability indicator 460. Similarly, the event availability indicator 460 can change when the device user has the communication capability to participate in the event 300. It will be appreciated by those of ordinary skill in the art that the device user can have the capability to participate in the event using an alternative device and/or communication channel. In this case, the event availability indicator 460 can change within the instant message user interface 360 of the instant message device 320 to inform the device user. Then, the device user can retrieve the event and/or information using the alternative device and/or communication channel.

Referring to FIG. 3, the device processor 340, in response to receiving a notification of the presence of an event, retrieves the plurality of communication capabilities 410 from the device memory 350. When the plurality of communication capabilities 410 provide the capability for the device user to participate in the event 300 using the instant message device 320, the device processor 340 sends a command to the instant message user interface 360 to change the event availability indicator 460. Alternatively, the device processor 340, in response to receiving a notification of the presence of an event, queries the device user to determine whether the communication capabilities of the device user provide the capability for the device user to participate in the event 300. When the device user has the communication capability to participate in the event, the device processor 340 sends a command to the instant message user interface 360 to change the event availability indicator 460.

For example, the device user can add the event identifier 430 for his/her favorite football team to the instant message user interface 360 of his/her instant message device 320. When a football game for the favorite football team was about to start or an official event/announcement/chat session about the football team was about to start, the owner of the football screen name would log into the instant message communication system 100 using the server 110. Alternatively, the server 110 can automatically detect the event and log onto the instant message communication system 100. In response, the event status 440 associated with the event identifier 430 for the football team would change on the instant message user interface 360. In one embodiment, the event presence indicator 450 and/or the event availability indicator 460 also changes. In one embodiment, after the presence notification has been distributed, an instant message can be sent from the server to the instant message device(s) informing of and/or linking them to the event details. In one embodiment, an event buddy list 465 is displayed for the event 300 along with the event identification 430 and other associated information as described herein. The event buddy list 465 includes all those device users within the instant message communication system 100 who have chosen the event 300 as an event of interest.

FIG. 5 illustrates one embodiment of an instant message 470 for use within the instant message communication system 100 of FIG. 1 in accordance with the present invention. The instant message 470 can be sent, for example, from the server 110 to one or more of the plurality of instant message devices 120. The instant message 470 preferably includes at least one of an instant message (IM) header 480, the screen name 290, a presence prompt 490, an availability prompt 500, and a participation method 510. The IM header 480 includes the information required to communicate the instant message 470 within the instant message communication system 100 in accordance with the particular protocol and/or system being utilized. The screen name 290 is one of the plurality of screen names 280 associated with the event 300 of which the notification is being sent. The presence prompt 490 is an indication within the instant message communication system 100 of the presence of the event 300.

The availability prompt 500 is an indication within the instant message communication system 100 of the availability of the event 300. The participation method 510 includes information of how to participate in the event 300. For example, the participation method 510 can include a URL of the web site in which the event 300 will be displayed. Alternatively, the participation method 510 can include a broadcast television channel in which the event 300 will be broadcast.

For example, when the event 300 is a television show relating to sharks, and the television channel has an additional active website link with a famous knowledgeable shark expert while the television show on sharks is being played, the instant message 470 can include the IM header 480, the screen name 290 of “sharks”, the presence prompt 490 indicating the presence of the shark expert on the website, the availability prompt 500 indicating when the shark expert is available, and the participation method 510 of the URL to the website. Within the same instant message 470, the information relating to the television broadcast can also be sent. For example the instant message 470 can further include the presence prompt 490 indicating the presence of the television show, the availability prompt 500 indicating when the television show is available, and the participation method 510 indicating the television channel. Alternatively, the instant message device 320 upon receipt of the presence prompt 490 can determine the availability of the event. For example, availability can include information relating to no access to the cable television, blacked out event, or an equivalent.

Within the instant message device 320, the device receiver 330 receives the instant message 470 preferably including the participation method 510. The device processor 340 retrieves the event 300 associated with the screen name 290 in response to the device receiver 330 receiving the instant message 470. Alternatively, and in accordance with the present invention, the device user can utilize another device to retrieve the event and/or the participation method.

In an alternate embodiment of the present invention, each screen name of the plurality of screen names 280 within the instant message communication system 100 represents a topic. The topic includes one or more events associated with the topic.

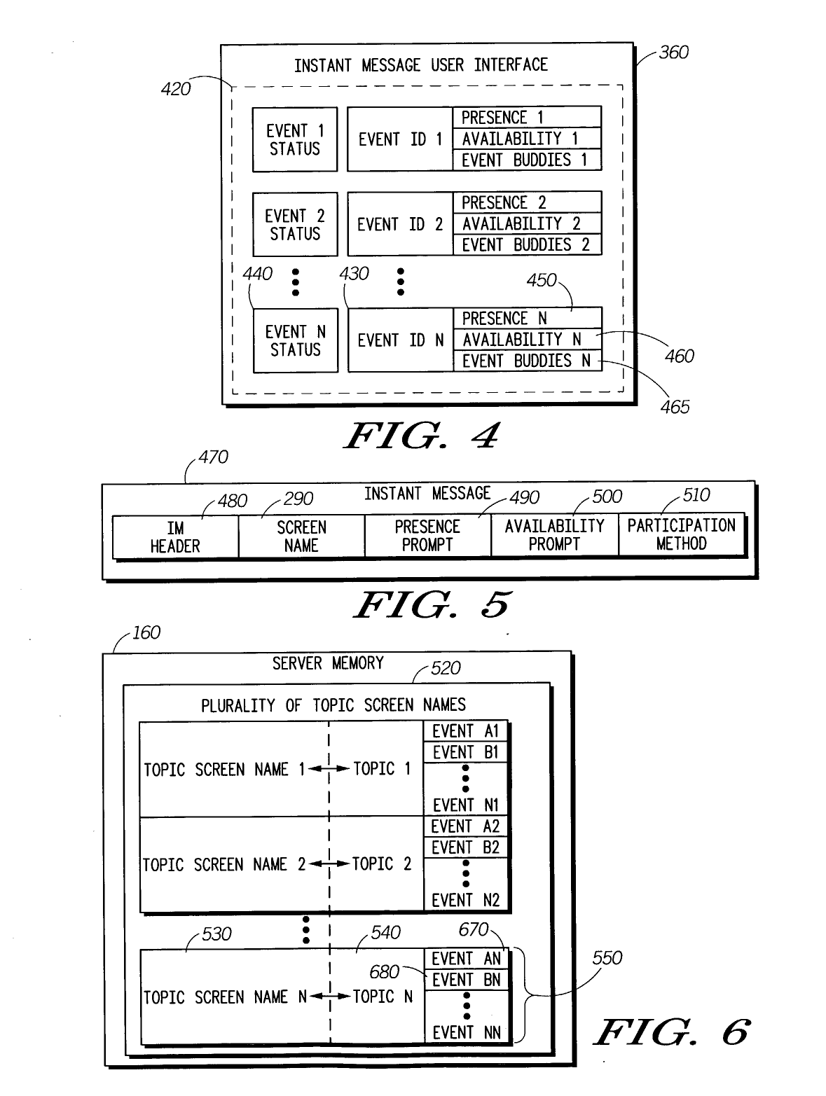

FIG. 6 illustrates one embodiment of the server memory 160 of the server 110 of FIG. 1 in accordance with the present invention. As illustrated, the server memory 160 preferably stores a plurality of topic screen names 520. Each topic screen name 530 of the plurality of topic screen names 520 represents a topic 540 including a plurality of topic events 550. The topic screen name 530, the topic 540, and the plurality of topic events 550 are stored within the server memory 160 for use in accordance with the present invention.

The server processor 150 of the server 110, in accordance with the present invention, activates at least one of the plurality of topic screen names 520 in response to the presence of at least one of the plurality of topic events 550 associated with the topic 540 represented by the topic screen name 530. The server processor 150 then sends a command signal to the server transmitter 170 to transmit a notification of the presence of the event associated with the topic 540.

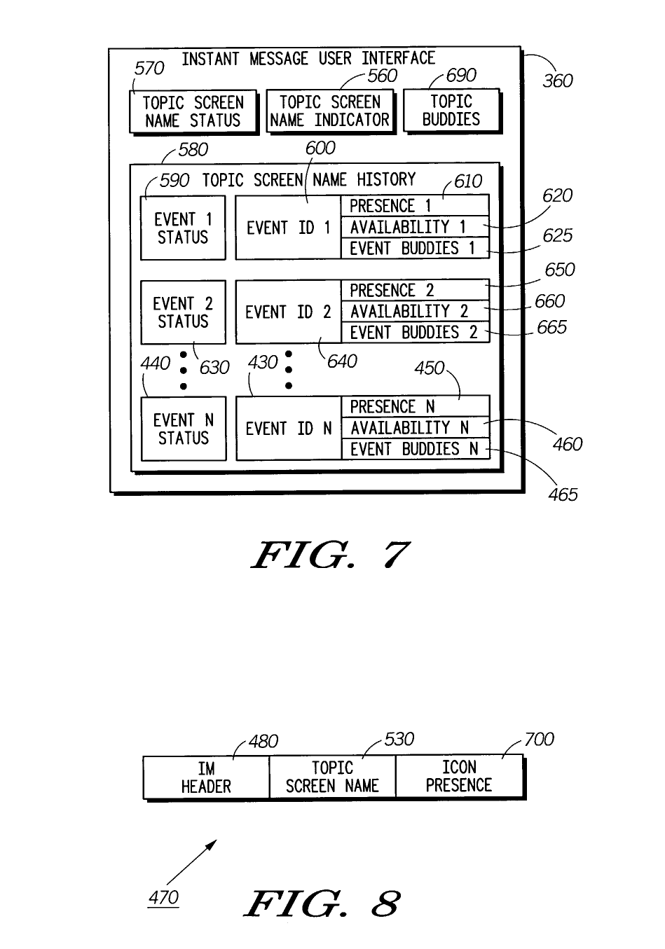

FIG. 7 illustrates one embodiment of the instant message user interface 360 of the instant message device 120 in accordance with the present invention. As illustrated, the instant message user interface 360 preferably includes information displayed regarding one or more topics of interest such as the topic 540. The device user can manually enter the one or more topic screen names for the one or more topics of interest into the instant message user interface 360. Alternatively, and in accordance with the present invention, the one or more topic screen names for the one or more topics of interest can be chosen from the plurality of topic screen names 530 stored in the server memory 160 of the server 110. For example, the server 110 can send a list of the plurality of topic screen names 530 and the device user can choose from this list. It will be appreciated by those of ordinary skill in the art that the instant message user interface 360 can further include one or more identifiers of people the device user is interested in communicating with (not shown) in accordance with the present invention. As illustrated in FIG. 7, preferably, for each topic 540, a topic screen name indicator 560, a topic screen name status 570, and a topic screen name history 580 can be displayed within the instant message user interface 360.

The topic screen name indicator 560 represents the topic 540 of the plurality of topics of interest to the device user. The topic screen name indicator 560, in accordance with the present invention, preferably is the screen name 290 associated with the topic 540. The topic screen name indicator 560 can be programmed by the device user to be continuously present within the instant message user interface 360 of the instant message device 320. Alternatively, the topic screen name indicator 560 can be added within the instant message user interface 360 in response to a physical event. It will be appreciated that the topic screen name indicator 560 can be added to the instant message user interface 360 as described herein or an equivalent.

Each topic screen name indicator 560 preferably has an associated topic screen name status 570. The topic screen name status 570 provides visual and/or audible notification to the device user of the presence of the information associated with the topic 540. This is a flexible, simple and effective way to allow the device user to provision the instant message device 320, on a personal basis, for notification of topics of interest to the device user. Preferably, the topic screen name status 570 changes in response to the notification from the server 110 of the presence of the information associated with the topic 540.

The topic screen name history 580 preferably includes information associated with the plurality of topic events 550 such as the topic screen name history 580 includes the event identifier 430, the event status indicator 440, the event presence indicator 450, and the event availability indicator 460 for the event 300 of the plurality of topic events 550 as described previously herein.

When the instant message device 320 receives a notification of the presence of one of the plurality of topic events 550 such as a first event 670, the topic screen name indicator 560 is displayed or changes on the instant message user interface 360. Additionally or alternatively, the topic screen name status 570 can change on the instant message user interface 360. Further, a first event identifier 600 is displayed or changes within the topic screen name history 580 of the instant message user interface 360. Additionally or alternatively, a first event status indicator 590 can change within the topic screen name history 580 of the instant message user interface 360. Similarly, a first event presence indicator 610 and/or a first event availability indicator 620 can be displayed and/or changed. A first event buddy list 625 is preferably also displayed. When the instant message device 320 receives a notification of the presence of one of the plurality of topic events 550 such as a second event 680, the topic screen name indicator 560 continues to be displayed on the instant message user interface 360. Additionally or alternatively, the topic screen name status 570 continues to be displayed as active on the instant message user interface 360. Further, a second event identifier 640 is displayed or changes within the topic screen name history 580 of the instant message user interface 360. Additionally or alternatively, a second event status indicator 630 can change within the topic screen name history 580 of the instant message user interface 360. Similarly, a second event presence indicator 650 and/or a second event availability indicator 660 can be displayed and/or changed. A second event buddy list 665 is preferably also displayed.

In one embodiment, the topic screen name indicator 560 is displayed continuously from the presence of the first event through the presence of the second event on the instant message user interface 360 in response to the instant message device 320 receiving notification of the presence of the second event 680 when the first event 670 is no longer present. When one screen name functions for multiple events such as described herein, one source can gather the event information for the instant message status changes and updates. Anytime an event was present the server would keep the instant status as “present” even if the event that initially caused the to change status to “present” was now over the event can maintain the “present” status if another event was still active. In one embodiment, a list of topic buddies 690 can be displayed along with the topic screen name indicator 560 on the instant message user interface 360. Alternatively or additionally, the list of event buddies 465 can be displayed along with the event indicator 430 on the instant message user interface 360.

The plurality of content 190, as described herein in FIG. 1 can include one or more event icons 270 associated with the topic 540. FIG. 8 illustrates one embodiment of the instant message 470 for use within the instant message communication system 100 of FIG. 1 in accordance with the present invention. The instant message 470 can be sent, for example, from the server 110 to one or more of the plurality of instant message devices 120. The instant message 470 preferably includes the instant message (IM) header 480, the topic screen name 530, and an icon presence indicator 700. When the server 110 detects the presence of one or more event icons 270, the server 110 sends the instant message 470 including the topic screen name 530 and the icon presence indicator 700 associated with the event 300 of the topic 540. In response to receiving the instant message 470, preferably, the topic screen name status 570 for the topic 540 changes and/or the topic screen name indicator 560 is displayed. Additionally or alternatively, the event identifier 430 and/or the event status indicator 440 changes and/or is displayed.

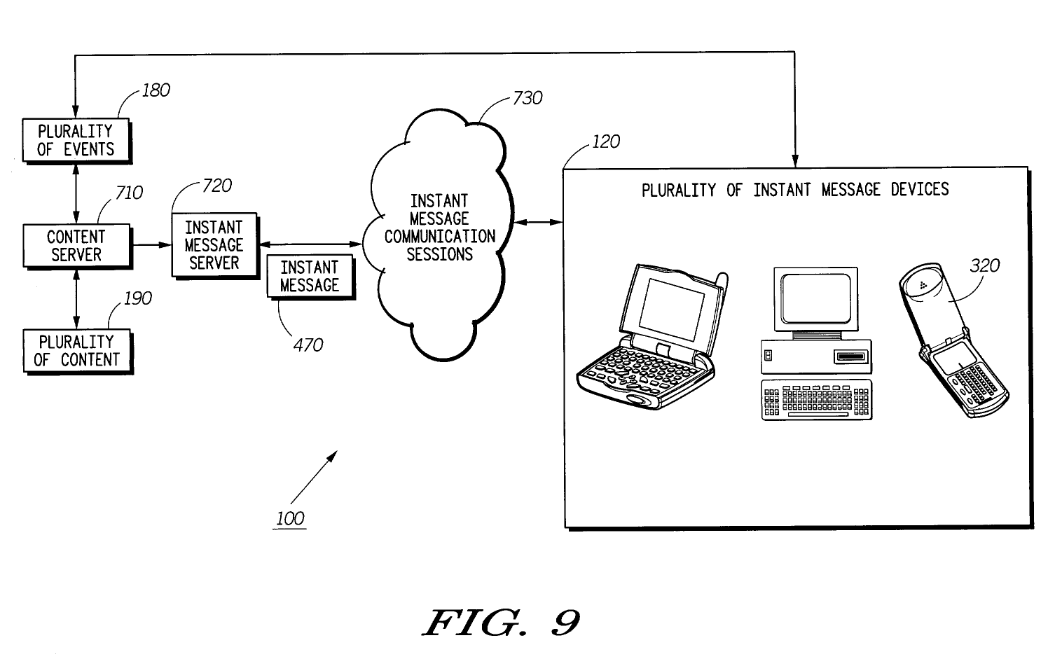

FIG. 9 illustrates an alternate embodiment of the instant message communication system 100 in accordance with the present invention. The instant message communication system 100 preferably includes a content server 710, an instant message server 720 and the plurality of instant message devices 120 selectively communicating within one or more of a plurality of instant message communication sessions 730.

Preferably, and in accordance with the present invention, the content server 710 is coupled to and receives information about the plurality of events 180. It will be appreciated by those of ordinary skill in the art that the plurality of events 180 can include, for example, physical events 210 such as sporting events, television or radio broadcast events 200, wireless content events 220, internet events 230, chat session events 240, or an equivalent. Each event can be separately designated within the instant message communications system 100, or alternatively can be grouped within one or more topics (not shown). For example, a general topic can be the National Football League (NFL) and all events relating to the NFL such as a live NFL game or a pay per view broadcasted NFL game can be grouped within the general topic. Preferably, each of the plurality of events has associated with it the plurality of event information 250, the method for event participation 260, one or more event icons 270, or an equivalent.

Preferably, and in accordance with the present invention, the content server 710 is further coupled to the plurality of content 190. The plurality of content 190, for example, can include one or more of the event icons 270 and/or one or more of the plurality of event information 250 associated with one or more of the plurality of events 180. The plurality of content 190, for example, can include weather, traffic, events, restaurants, shopping, services, sports, and the like.

The content server 710 can become aware of the presence of an event in a variety of ways. For example, the event provider can originate an event notification. The content server 710 receives the event notification via the content receiver 740. Alternatively, the event provider can send a schedule of events in advance. The content server 710 receives the schedule of events via the content receiver 740 and can store the schedule of events in the server memory 160 (not shown) for later retrieval by the content processor 750. Alternatively, the content server 710 can include one or more search engines (not shown) to identify the availability of one or more of the plurality of events 180.

The content server 710 is coupled to the instant message server 720. The content server 710 establishes communication with the instant message server 720 in response to the presence of one or more of the plurality of events 180 or one or more of the plurality of content 190 associated with the one or more of the plurality of events 180. The instant message server 720 manages the communication of one or more instant messages of a plurality of instant message communication sessions 730 among the plurality of instant message devices 120. Preferably, the instant message server 720 sends the instant message 470 in response to the content server 710 establishing communication with the instant message server 720.

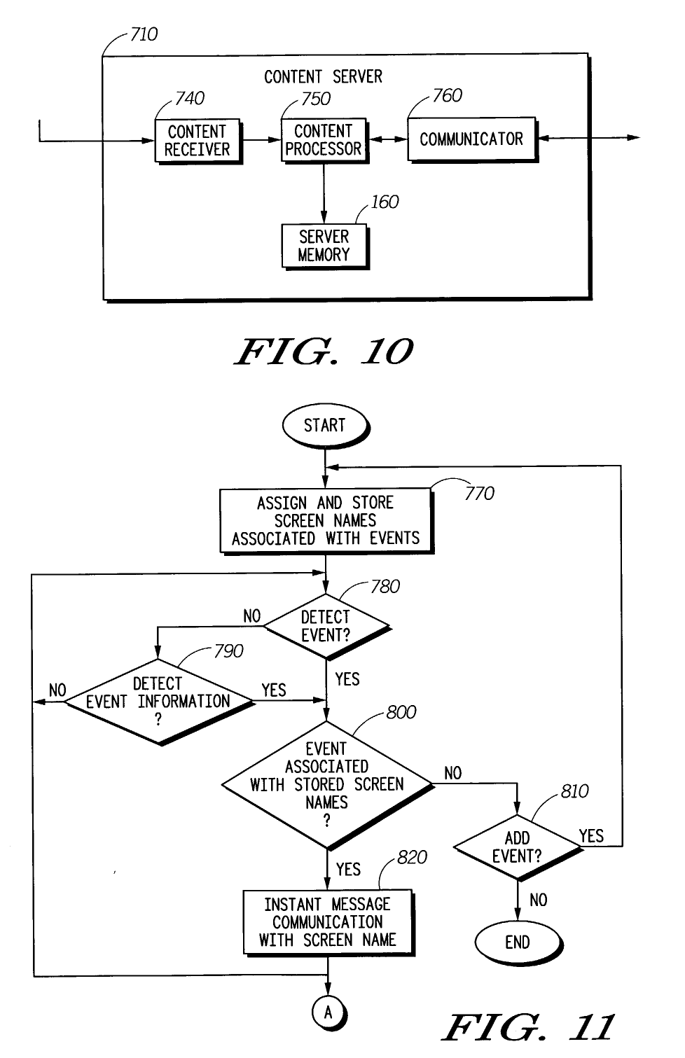

FIG. 10 illustrates an electronic block diagram of the content server 710 in accordance with the present invention. The content server 710 preferably includes a content receiver 740, a content processor 750, the server memory 160, and a communicator 760. In one embodiment of the present invention, the content receiver 740 functions by intercepting transmitted signals from a wireless communication system. It will be appreciated by one of ordinary skill in the art that the content receiver 740 can function by intercepting transmitted signals from any wireless radio frequency (RF) channel, for example, a one or two-way pager channel, a mobile cellular telephone channel, or a mobile radio channel. Similarly, it will be appreciated by one of ordinary skill in the art that the content receiver 740 can function by intercepting transmitted signals from other types of wireless communication channels such as infrared channels and Bluetooth channels. In another embodiment, the content receiver 740 functions by intercepting signals from a wired communication system, for example from a local area network (LAN) or a wide area network (WAN) or a combination of both. The content receiver 740 can operate by receiving signals from a network that uses a physical network such as ARCNET, Ethernet, Token-ring, Local Talk or other network media. The content receiver 740 can operate by receiving signals over a LAN that employs any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures. Further the content receiver 740 can operate by receiving signals over a WAN that uses a different physical network media such as X.25, Frame Relay, ISDN, Modem dial-up or other media to connect other computers or other local area networks. It will be appreciated by one of ordinary skill in the art that the content receiver 740 can operate using any combination of the communication systems mentioned herein or an equivalent. Preferably, and in accordance with the present invention, the content receiver 740 is coupled to and receives information about the plurality of events 180. Similarly, and in accordance with the present invention, the content receiver 740 is further coupled to the plurality of content 190.

Within the content server 710, the content receiver 740 is coupled to the content processor 750. The content processor 750 utilizes conventional signal processing techniques for processing received signals from the content receiver 740. Preferably, the content processor 750 is similar to the MC68328 micro-controller manufactured by Motorola, Inc. of Schaumburg, Ill. It will be appreciated that other similar processors can be utilized for the content processor 750, and that additional processors of the same or alternative type can be added as required to handle the processing requirements of the content processor 750.

To perform the necessary functions of the content server 710, the content processor 750 is coupled to the server memory 160, which preferably includes a random access memory (RAM), a read-only memory (ROM), an electrically erasable programmable read-only memory (EEPROM), and/or a magnetic storage memory (for example a hard drive). The server memory 160 is as illustrated for FIGS. 2 and 6 and as described previously herein.

The communicator 760 is coupled to and receives one or more command signals from the content processor 750, and in response to a command signal, establishes communication with the instant message server 720 within the instant message communication system 100. The content server 710 can establish communication with the instant message server 720 using at least one of the plurality of screen names 280 stored in the server memory 160 in response to the presence of the event 300, associated content, and/or the plurality of event information 250. Similarly, the content server 710 can establish communication with the instant message server 720 using one of the plurality of topic screen names 530 stored in the server memory 160 in response to the presence of an event and/or content associated with the topic 540.

In one embodiment of the present invention, the communicator 760 functions by sending and receiving signals via a wireless communication system. It will be appreciated by one of ordinary skill in the art that the communicator 760 can function by sending and receiving signals via any wireless radio frequency (RF) channel, for example, a one or two-way pager channel, a mobile cellular telephone channel, or a mobile radio channel. Similarly, it will be appreciated by one of ordinary skill in the art that the communicator 760 can function by sending signals via other types of wireless communication channels such as infrared channels and Bluetooth channels. In another embodiment, the communicator 760 functions by sending and receiving signals via a wired communication system, for example from a local area network (LAN) or a wide area network (WAN) or a combination of both. The communicator 760 can operate by sending signals via a network that uses a physical network such as ARCNET, Ethernet, Token-ring, Local Talk or other network media. The communicator 760 can operate by sending signals over a LAN that employs any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures. Further the communicator 760 can operate by sending and receiving signals over a WAN that uses a different physical network media such as X.25, Frame Relay, ISDN, Modem dial-up or other media to connect other computers or other local area networks. It will be appreciated by one of ordinary skill in the art that the communicator 760 can operate using any combination of the communication systems mentioned herein or an equivalent.

The content processor 750, in accordance with the present invention, is programmed to use the communicator 760 to establish communication with the instant message server 720 utilizing at least one of the plurality of screen names 280 such as the screen name 290 stored in the server memory 160 in response to the presence of the event 300 represented by the screen name 290.

The content server 710 can become aware of the presence of an event in a variety of ways. For example, the event provider can originate an event notification. The content server 710 receives the event notification via the content receiver 740. Alternatively, the event provider can send a schedule of events in advance. The content server 710 receives the schedule of events via the content receiver 740 and can store the schedule of events in the server memory 160 (not shown) for later retrieval by the content processor 750. Alternatively, the content server 710 can include one or more search engines (not shown) to identify the availability of one or more of the plurality of events 180.

The content processor 750, in accordance with the present invention, can further be programmed to use the communicator 760 to establish communication with the instant message server 720 utilizing at least one of the plurality of screen names 280 such as the screen name 290 stored in the server memory 160 in response to the presence of the plurality of event information 250 about the event 300 represented by the screen name 290. Similarly, the content processor 750, in accordance with the present invention, can further be programmed to use the communicator 760 to establish communication with the instant message server 720 utilizing at least one of the plurality of screen names 280 such as the screen name 290 stored in the server memory 160 in response to the presence of the one or more event icons 270 associated with the event 300 represented by the screen name 290.

FIG. 11 illustrates the operation of the instant message communication system 100 of FIGS. 1 and 9 in accordance with the present invention. Specifically, FIG. 11 illustrates a method for providing notification of one or more events within an instant message communication system. As illustrated, the process begins with Step 770 in which at least one screen name 290 of the plurality of screen names 280 is associated with at least one event 300 of the plurality of events 180 and stored in the server memory 160. It will be appreciated by those of ordinary skill in the art that the server memory 160 can be contained within the server 110 of FIG. 1 or the content server 710 of FIG. 9 in accordance with the present invention. Next, in Step 780, the process determines whether the presence of at least one event of the plurality of events 180 is detected. For example, the server 110 of FIG. 1 can detect the presence of the event as described previously herein. Similarly, the content server 710 of FIG. 9 can detect the presence of the event as described previously herein. In Step 790, when no event presence is detected in Step 780, the process determines whether the presence of an event information of the plurality of event information 250 associated with at least one event of the plurality of events 180 is detected. For example, the server 110 of FIG. 1 can detect the presence of the event information as described previously herein. Similarly, the content server 710 of FIG. 9 can detect the presence of the event information as described previously herein. When no event information presence is detected in Step 790, the process cycles back to Step 780. When at least one event is detected in Step 780 or when at least one event information is detected in Step 790, in Step 800, the process determines whether the event whose presence is detected is associated with the stored plurality of screen names 280. For example, within the server 110 of FIG. 1, the server receiver 140 can detect the presence of an event or alternatively the presence of event information. The server processor 150 is programmed to compare the event for which a presence of the event or event information has been detected with the plurality of screen names 280 stored within the server memory 160. Similarly, within the content server 710 of FIGS. 9 and 10, the content receiver 740 can detect the presence of an event or alternatively the presence of event information. The content processor 750 is programmed to compare the event for which a presence of the event or event information has been detected with the plurality of screen names 280 stored within the server memory 160. In Step 810, when the event is not associated with at least one of the plurality of screen names 180 stored in the server memory 160 in Step 800, the process determines whether the event for which the presence or the event information was received is to be assigned a screen name and stored within the server memory 160. For example, the event presence notification can include an instruction to add the event. Alternatively, the server processor 150 of the server 110 or the content processor 750 of the content server 710 can be programmed with an algorithm to determine whether to add the event. Further, a device user within the instant message communication system 100 can manually be queried and respond as to whether or not to assign and store a screen name for the new event. When a screen name is not to be assigned for the new event, the process ends. When a screen name is to be assigned for the new event, the process returns to Step 770. In Step 820, when the event for which the event presence or the event information presence has been detected is associated with a stored screen name, a communication within the instant message communication system 100 using the screen name is established. For example, the server 110 can sign onto the instant message communication system 100 using the screen name 290. Similarly, the content server 710 can establish communication with the instant message server 720 of the instant message communication system 100. The operation then proceeds to node A and also returns to Step 780 to continue checking for the detection of the presence of an event within the instant message communication system 100.

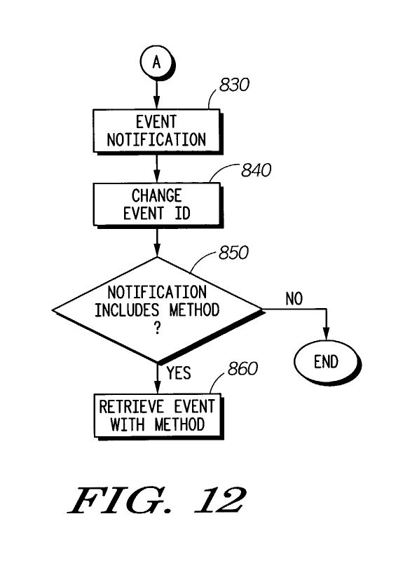

FIG. 12 illustrates one embodiment of the operation of the instant message communication system 100 starting from node A in accordance with the present invention. As illustrated, in Step 830 an event notification is communicated within the instant message communication system 100. In one embodiment, the event notification, in accordance with the present invention, is the instant message 470 sent from the server 110 to the plurality of instant message devices 120 within the instant message communication system 100 of FIG. 1. Alternatively, the event notification, in accordance with the present invention, is the instant message 470 sent from the instant message server 720 to the to the plurality of instant message devices 120 within the instant message communication system 100 of FIG. 9 as described previously herein. Next, in Step 840, an event identification is changed within the instant message user interface 360 of at least one of the plurality of instant message devices 120. In accordance with the present invention, the event identification 430, the event status 440, the event presence indicator 450, the event availability indicator 460, and/or an equivalent can change. It will be appreciated by those of ordinary skill in the art that any identification associated with the event and/or screen name assigned to the event can change within the instant message user interface 360 in accordance with the present invention. Next, in Step 850, the process determines whether the participation method 510 is included within the event notification. When no participation method is included, the process ends. In Step 860, when the participation method 510 is included within the event notification, at least one of the plurality of instant message devices 120 retrieves the event using the participation method 510.

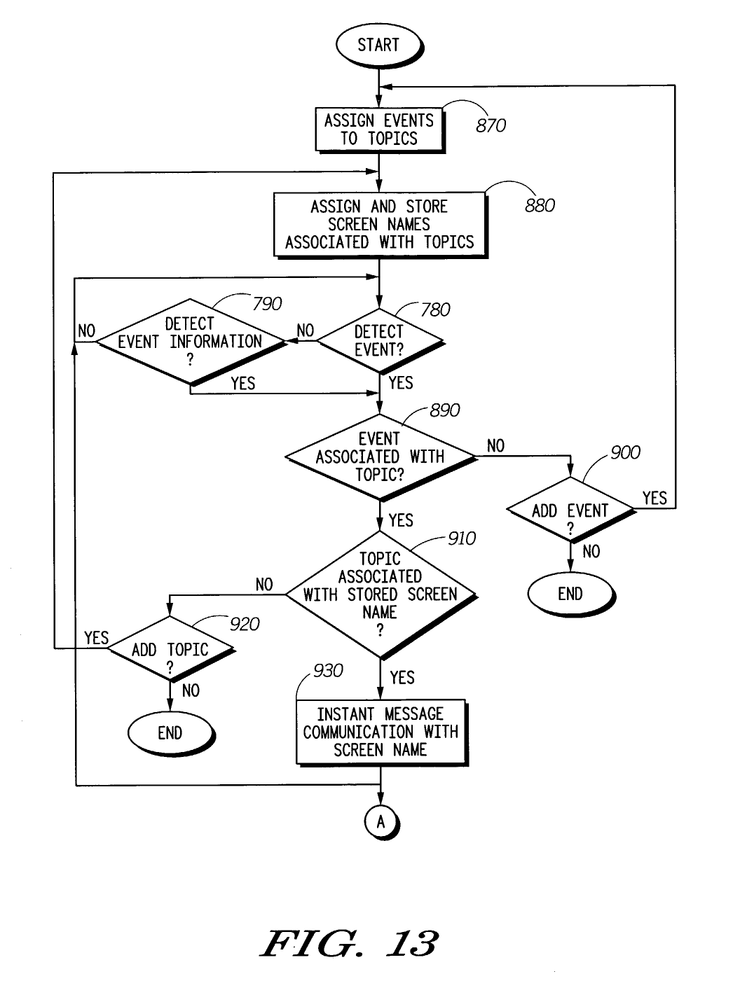

FIG. 13 illustrates one embodiment of the operation of the instant message communication system 100 in accordance with the present invention. Specifically, FIG. 13 illustrates the operation of the instant message communication system 100 using at least one topic 540 for grouping one or more of the plurality of topic events 550. The process begins with Step 870 in which one or more of the plurality of topic events 550 are assigned to one or more topics such as the topic 540. Next, in Step 880, at least one topic screen name 530 of the plurality of topic screen names 520 is associated with at least one of the plurality of topic events 550 and stored in the server memory 160. It will be appreciated by those of ordinary skill in the art that the server memory 160 can be contained within the server 110 of FIG. 1 or the content server 710 of FIGS. 9 and 10 in accordance with the present invention. Next, in Step 780, the process determines whether the presence of at least one event of the plurality of events 180 is detected. For example, the server 110 of FIG. 1 can detect the presence of the event as described previously herein. Similarly, the content server 710 of FIGS. 9 and 10 can detect the presence of the event as described previously herein. In Step 790, when no event presence is detected in Step 780, the process determines whether the presence of an event information of the plurality of event information 250 associated with at least one event of the plurality of events 180 is detected. For example, the server 110 of FIG. 1 can detect the presence of the event information as described previously herein. Similarly, the content server 710 of FIGS. 9 and 10 can detect the presence of the event information as described previously herein. When no event information presence is detected in Step 790, the process cycles back to Step 780. When at least one event is detected in Step 780 or when at least one event information is detected in Step 790, in Step 890, the process determines whether the event in which the presence has been detected or in which event information has been detected is associated with one or more topics such as the topic 540. For example, the server processor 150 of the server 110 of FIG. 1 can be programmed to compare the event to the topics and associated plurality of topic events 550 stored in the server memory 160. Similarly, the content processor 750 of the content server 710 of FIGS. 9 and 10 can be programmed to compare the event to the topics stored in the server memory 160 and associated plurality of topic events 550. In Step 900, when the event is not associated with at least one topic 540 stored in memory, the process determines whether the event should be added to one or more topics. For example, the event presence notification can include an instruction to add the event to one or more topics. Alternatively, the server processor 150 of the server 110 or the content processor 750 of the content server 710 can be programmed with an algorithm to determine whether to add the event to one or more topics. (i.e. using keywords) Further, a device user within the instant message communication system 100 can manually be queried and respond as to whether or not to assign and store the new event with one or more topics. When the event is not to be added to at least one topic, the process ends. When the event is to be added to at least one topic, the process cycles back to Step 870. In Step 910, when the event is associated with at least one topic in Step 890, the process next determines whether the topic 540 is associated with at least one of the plurality of topic screen names 520 stored in the server memory 160. For example, within the server 110 of FIG. 1, the server processor 150 can be programmed to compare the topic with the plurality of topic screen names 520 stored within the server memory 160. Similarly, within the content server 710 of FIGS. 9 and 10, the content processor 750 can be programmed to compare the topic with the plurality of topic screen names 520 stored within the server memory 160. In Step 930, when the topic is associated with at least one stored topic screen name 530, a communication within the instant message communication system 100 using the topic screen name 530 is established. For example, the server 110 can sign onto the instant message communication system 100 using the topic screen name 530. Similarly, the content server 710 can establish communication with the instant message server 720 of the instant message communication system 100. The operation then proceeds to node A and also returns to Step 780 to continue checking for the detection of the presence of an event within the instant message communication system 100. In Step 920, when the topic 540 is not associated with at least one of the plurality of topic screen names 520 stored in memory, the process determines whether the topic 540 should be added along with an associated topic screen name. For example, the event presence notification can include an instruction to add the topic 540. Alternatively, the server processor 150 of the server 110 or the content processor 750 of the content server 710 can be programmed with an algorithm to determine whether to add the topic. Further, a device user within the instant message communication system 100 can manually be queried and respond as to whether or not to assign and store the new topic with one or more topic screen names. When topic is not to be added, the process ends. When the topic is to be added, the process cycles back to Step 880.

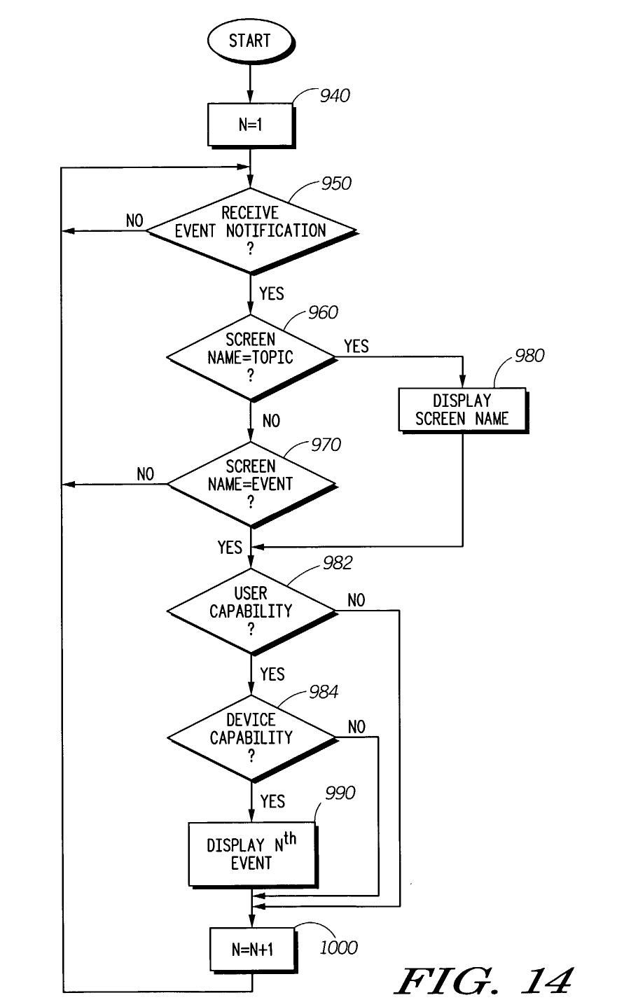

FIG. 14 illustrates one embodiment of the operation of the instant message device 320 within the instant message communication system 100 in accordance with the present invention. As illustrated, the process begins at Step 940 with a counter set to N=1. Next, in Step 950, the process determines whether an event notification has been received. For example, the device receiver 330 of the instant message device 320 can receive the instant message 470 including notification of the presence of at least one event of the plurality of events 180. When no event presence notification is received, the process cycles back to Step 950 and periodically checks for receipt. In Step 960, when an event presence notification is received, the instant message device 320 determines whether or not the screen name received is associated with at least one topic. For example, the device processor 340 of the instant message device 320 can be programmed to compare the screen name received to the list of topic screen names of interest 405 stored in the device memory 350. In Step 980, when the topic is associated with at least one screen name, the screen name is displayed on the instant message device 320. For example, the topic screen name 530 for the topic 540 can be displayed on the instant message user interface 360 of the instant message device 320. In Step 970, when the topic is not associated with at least one screen name, the instant message device 320 determines whether or not the screen name received is associated with at least one event. For example, the device processor 340 of the instant message device 320 can be programmed to compare the screen name received to the list of event screen names of interest 415 stored in the device memory 350. When the screen name is not associated with at least one of event, the process cycles back to Step 950. When the screen name is associated with at least one event in Step 970, and after the screen name is displayed in Step 980, in Step 982, the process queries whether the device user of the instant message device 320 has the communication capability to participate in the event. Next, in Step 984, when the device user has the communication capability to participate in the event, the process queries whether the instant message device 320 has the capability to participate in the event. Next, in Step 990, when the instant message device 320 has the capability to participate in the event, the Nth event is displayed on the instant message user interface 360 of the instant message device 320. The Nth event can be displayed by changing any combination of the event identifier, the event status indicator, the event presence indicator, the event availability indicator, or an equivalent. Next, and when the device user does not have the communication capability to participate in the event or the instant message device 320 does not have the capability to participate in the event, in Step 1000, the counter is incremented to N=N+1. The process then cycles back to Step 950.

The invention as described herein provides the ability to deliver a notification to viewers about the presence and availability of an event of interest using instant message communication technology. Although the invention has been described in terms of preferred embodiments, it will be obvious to those skilled in the art that various alterations and modifications can be made without departing from the invention. Accordingly, it is intended that all such alterations and modifications be considered as within the spirit and scope of the invention as defined by the appended claims.

What is claimed is:

1. An instant message communication system for providing notification of one or more events, the instant message communication system comprising:
a server comprising:
a server memory for storing a plurality of screen names, wherein each of the plurality of screen names represents one or more events, and
a server processor coupled to the server memory, wherein the server processor is programmed to activate at least one of the plurality of screen names in response to the presence of one or more events represented by at least one of the plurality of screen names.

2. An instant message communication system as recited in claim 1 wherein the server processor is further programmed to activate at least one of the plurality of screen names in response to the presence of a plurality of event information about the one or more events represented by the at least one of the plurality of screen names.

3. An instant message communication system as recited in claim 1 wherein the server processor is further programmed to activate at least one of the plurality of screen names in response to the presence of one or more event icons associated with the one or more events represented by the at least one of the plurality of screen names.

4. An instant message communication system as recited in claim 1, wherein the server provides a notification of the presence of the event, the instant message communication system further comprising:
one or more instant message devices, wherein each instant message device includes an instant message user interface, wherein the instant message user interface displays for each event of interest at least one identifier selected from the group of identifiers consisting of an event identifier, an event status, an event presence indicator, an event availability indicator, and an event buddy list, and further wherein at least one identifier changes in response to the notification from the server of the presence of the event.

5. An instant message communication system as recited in claim 4 wherein at least one identifier of the group of identifiers is activated within the instant message user interface in response to a physical event.

6. An instant message communication system as recited in claim 4 wherein at least one identifier of the group of identifiers is activated within the instant message user interface when the instant message device includes the capability to participate in the event.

7. An instant message communication system as recited in claim 4 wherein at least one identifier of the group of identifiers is activated within the instant message user interface when the device user of the instant message device has the communication capability to participate in the event.

8. An instant message communication system as recited in claim 1 wherein the server processor is further programmed to send a command signal to the server transmitter and further wherein the server transmitter sends an instant message in response to the command signal.

9. An instant message communication system as recited in claim 8 wherein the instant message further includes a presence prompt for the event.

10. An instant message communication system as recited in claim 8 wherein the instant message further includes an availability prompt for the event.

11. An instant message communication system as recited in claim 8 wherein the instant message further includes a participation method for participating in the event.

12. An instant message communication system as recited in claim 11 further comprising:
an instant message device, comprising:
a device receiver for receiving the instant message including the participation method, and
a device processor coupled to the device receiver for retrieving the event using the participation method in response to receiving the instant message.

13. An instant message communication system for providing notification of one or more events comprising:
a server comprising:
a server memory for storing a plurality of topic screen names, wherein each of the plurality of topic screen names represents a topic, and for storing a plurality of topic events associated with the topic,
a server processor coupled to the server memory, wherein the server processor is programmed to activate at least one of the plurality of screen names in response to the presence of at least one topic event associated with the topic represented by the at least one of the plurality of screen names, and
a server transmitter for sending a notification of the presence of the one or more events; and
one or more instant message devices, wherein each instant message device includes an instant message user interface, wherein the instant message user interface displays for each of the plurality of topic screen names:
a topic screen name indicator, and
a topic screen name history, wherein the topic screen name history includes at least one identifier selected from the group of identifiers consisting of an event identifier, an event status, an event presence indicator, an event availability indicator, and an event buddy list, and further wherein at least one identifier changes in response to the instant message device receiving the presence of the event notification.

14. An instant message communication system as recited in claim 13 wherein the plurality of topic events for the topic screen name for the topic includes a first event and a second event, and further wherein the topic screen name is displayed continuously from the presence of the first event through the presence of the second event on the instant message user interface in response to the instant message device receiving notification of the presence of the second event when the first event is no longer present.

15. An instant message communication system as recited in claim 13 wherein the instant message user interface further displays a topic screen name status for each of the plurality of topic screen names.

16. An instant message communication system as recited in claim 13 wherein the instant message user interface further displays a list of topic buddies for each of the plurality of topic screen names.

17. An instant message communication system for providing notification of one or more events comprising:
a server for receiving and processing a plurality of content, wherein the plurality of content includes one or more icons associated with one or more events and for sending a notification message including the presence of an icon associated with an event; and
one or more instant message devices coupled to the server, wherein each instant message device comprises:
a device receiver for receiving the notification message including the presence of the icon,
a device processor coupled to the device receiver for processing the message including the presence of the icon, wherein the device processor is programmed to send a control signal to an instant message user interface in response to receiving and processing the icon, and
the instant message user interface coupled to the device processor, wherein the instant message user interface includes at least one identifier selected from the group of identifiers consisting of an event identifier, an event status, an event presence indicator, an event availability indicator, and an event buddy list, and further wherein at least one identifier changes in response to the instant message user interface receiving the control signal from the device processor.

18. An instant message communication system as recited in claim 17 wherein the server further comprises:
a server memory for storing the one or more icons associated with the one or more events,
a server processor coupled to the server memory, wherein the server processor is programmed to activate at least one screen name in response to the presence of at least one icon associated with at least one event, and
a transmitter for sending a notification of the presence of the icon.

19. An instant message communication system for providing notification of one or more events comprising:
a content server comprising:
a server memory for storing a plurality of screen names, wherein each of the plurality of screen names represents an event, and
a content processor coupled to the server memory, wherein the content processor is programmed to establish communication with an instant message server utilizing at least one of the plurality of screen names in response to the presence of the event represented by the at least one of the plurality of screen names; and
an instant message server coupled to the content server for managing the communication of one or more instant messages among a plurality of instant message devices, wherein the instant message server sends an instant message in response to the content server establishing communication with the instant message server.

20. An instant message communication system as recited in claim 19, wherein each instant message device includes an instant message user interface, wherein the instant message user interface, wherein the instant message user interface includes at least one identifier selected from the group of identifiers consisting of an event identifier, an event status, an event presence indicator, an event availability indicator, and an event buddy list, and further wherein at least one identifier changes in response to the instant message device receiving the instant message.

21. An instant message communication system as recited in claim 19 wherein the content processor is further programmed to establish communication with the instant message server utilizing at least one of the plurality of screen names in response to the presence of information about the event represented by the at least one of the plurality of screen names.

22. An instant message communication system as recited in claim 19 wherein the content processor is further programmed to search for the presence of the event and further programmed to communicate an event presence prompt for the event based upon the search results to the instant message server, and further wherein the instant message server sends an instant message including the event presence prompt in response to receiving the event presence prompt.

23. An instant message communication system as recited in claim 22, wherein each instant message device includes an instant message user interface, least one identifier selected from the group of identifiers consisting of an event identifier, an event status, an event presence indicator, an event availability indicator, and an event buddy list, and further wherein at least one identifier changes in response to the instant message device receiving the instant message including the event presence prompt.

24. An instant message communication system as recited in claim 19 wherein the content processor is further programmed to search for the availability of the event and further programmed to communicate an event availability prompt for the event based upon the search results to the instant message server, and further wherein the instant message server sends an instant message including the event availability prompt in response to receiving the event availability prompt.

25. An instant message communication system as recited in claim 24, wherein each instant message device includes an instant message user interface, wherein the instant message user interface includes at least one identifier selected from the group of identifiers consisting of an event identifier, an event status, an event presence indicator, an event availability indicator, and an event buddy list, and further wherein at least one identifier changes in response to the instant message device receiving the instant message including the event availability prompt.

26. An instant message communication system as recited in claim 25 wherein the at least one identifier changes in response to the instant message device receiving the instant message including the event availability prompt when the instant message device includes the capability to participate in the event.

27. An instant message communication system as recited in claim 25 wherein the wherein the at least one identifier changes in response to the instant message device receiving the instant message including the event availability prompt when the device user of the instant message device has the communication capability to participate in the event.

28. An instant message communication system as recited in claim 19 wherein the instant message server further sends an instant message including a participation method, and further wherein each of the plurality of instant message devices comprises:
a device receiver for receiving the instant message including the participation method, and
a device processor coupled to the device receiver for retrieving the event using the participation method in response to receiving the instant message.

29. An instant message communication system as recited in claim 28 wherein each of the plurality of instant message devices further comprises:
an instant message user interface, wherein the instant message user interface includes wherein the instant message user interface includes at least one identifier selected from the group of identifiers consisting of an event identifier, an event status, an event presence indicator, an event availability indicator, and an event buddy list, and further wherein at least one identifier changes in response to the instant message device receiving the instant message.

30. An instant message communication system for providing notification of one or more events comprising:
a content server comprising:
a server memory for storing a plurality of screen names, wherein each of the plurality of screen names represents a topic, and
a content processor coupled to the server memory, wherein the content processor is programmed to establish communication with an instant message server utilizing at least one of the plurality of screen names in response to the presence of at least one event associated with the topic represented by the at least one of the plurality of screen names;
an instant message server coupled to the content server for managing the communication of one or more instant messages among a plurality of instant message devices, wherein the instant message server sends an instant message in response to the content server establishing communication with the instant message server; and
one or more instant message devices, wherein each instant message device includes an instant message user interface, wherein the instant message user interface displays for each of the plurality of topic screen names:
a topic screen name indicator, and
a topic screen name history, wherein the topic screen name history includes at least one identifier selected from the group of identifiers consisting of an event identifier, an event status, an event presence indicator, an event availability indicator, and an event buddy list, and further wherein at least one identifier changes in response to the instant message device receiving the presence of the event notification.

31. An instant message communication system as recited in claim 30 wherein the plurality of topic events for the topic screen name for the topic includes a first event and a second event, and further wherein the topic screen name is displayed continuously from the presence of the first event through the presence of the second eventon the instant message user interface in response to the instant message device receiving notification of the presence of the second event when the first event is no longer present.

32. An instant message communication system for providing notification of one or more events comprising:
a content server for receiving and processing a plurality of content, wherein the plurality of content includes one or more icons associated with one or more events, the content server comprising:
a server memory for storing the one or more icons associated with the one or more events and further for storing a plurality of screen names, wherein each of the plurality of screen names represents at least one event, and
a content processor coupled to the server memory, wherein the content processor is programmed to establish communication with an instant message server utilizing at least one of the plurality of screen names in response to the content server receiving at least one icon; and
the instant message server coupled to the content server for managing the communication of one or more instant messages among a plurality of instant message devices, wherein the instant message server sends an instant message in response to the content server establishing communication with the instant message server.

33. An instant message communication system as recited in claim 32, wherein each of the plurality of instant message devices comprises:
a device receiver for receiving the instant message,
a device processor coupled to the device receiver for processing the instant message, wherein the device processor is programmed to send a control signal to an instant message user interface in response to receiving and processing the instant message, and
the instant message user interface coupled to the device processor wherein the instant message user interface includes at least one identifier selected from the group of identifiers consisting of an event identifier, an event status, an event presence indicator, an event availability indicator, and an event buddy list, and further wherein at least one identifier changes in response to receiving the control signal from the device processor.

34. A method for providing notification of one or more events within an instant message communication system having a server, the method comprising:
in the server:
storing a plurality of screen names, wherein each screen name represents one or more events;
detecting the presence of at least one event represented by at least one screen name of the plurality of screen names; and
activating the screen name indicating the presence of the event.

35. A method for providing notification of one or more events within an instant message communication system as recited in claim 34, wherein the instant message communication system further includes one or more instant message devices, the method further comprising:
in the server:
sending a notification of the presence of the event; and
in at least one of the instant message devices having an instant message user interface including at least one identifier selected from the group of identifiers consisting of an event identifier, an event status, an event presence indicator, an event availability indicator, and an event buddy list:
receiving the notification of the presence of the event; and
changing at least one identifier changes in response to the instant message device receiving the notification of the presence of the event.

36. A method for providing notification of one or more events within an instant message communication system as recited in claim 35 further comprising:
in the server:
sending an instant message including a participation method; and
in the at least one of the instant message devices:
receiving the instant message including the participation method, and
retrieving the event using the participation method.

37. A method for providing notification of one or more events within an instant message communication system having a server, the method comprising:
in the server:
storing a plurality of screen names, wherein each screen name represents one or more events;
detecting the presence of event information associated with at least one event represented by at least one screen name of the plurality of screen names; and
activating the screen name indicating the presence of the event information.

38. A method for providing notification of one or more events within an instant message communication system as recited in claim 37, wherein the instant message communication system further includes one or more instant message devices, the method further comprising:
in the server:
sending a notification of the presence of the event; and
in at least one of the instant message devices having an instant message user interface including at least one identifier selected from the group of identifiers consisting of an event identifier, an event status, an event presence indicator, an event availability indicator, and an event buddy list:
receiving the notification of the presence of the event; and
changing at least one identifier changes in response to the instant message device receiving the notification of the presence of the event.

39. A method for providing notification of one or more events within an instant message communication system as recited in claim 38 further comprising:
in the server:
sending an instant message including a participation method; and
in the at least one of the instant message devices:
receiving the instant message including the participation method, and
retrieving the event using the participation method.

40. A method for providing notification of one or more events within an instant message communication system as recited in claim 39 wherein the event information received includes at least one event icon associated with the event.

41. A method for providing notification of one or more events within an instant message communication system having a server, the method comprising:
in the server:
storing a plurality of topic screen names, wherein each topic screen name represents at least one topic, wherein each topic includes one or more associated events;
detecting the presence of a first event associated with a topic represented by at least one topic screen name of the plurality of topic screen names; and
activating the topic screen name indicating the presence of the topic.

42. A method for providing notification of one or more events within an instant message communication system as recited in claim 41, wherein the instant message communication system further includes one or more instant message devices, the method further comprising:
in the server:
sending a notification of the presence of the first event; and
in at least one of the instant message devices:
receiving the notification of the presence of the first event; and
displaying a topic screen name indicator for the topic within an instant message user interface of the instant message device in response to receiving the notification of the presence of the first event.

43. A method for providing notification of one or more events within an instant message communication system as recited in claim 42 further comprising:
in the server,
detecting the first event associated with the topic is no longer present;
sending a notification that the first event is no longer present;
detecting the presence of a second event associated with the same topic represented by the same topic screen name; and
sending a notification of the presence of the second event associated with the topic; and
in at least one of the instant message devices:
receiving the notification of the absence of the first event associated with the topic;
receiving the notification of the presence of the second event associated with the topic; and
continuously from the presence of the first event through the presence of the second event displaying the topic screen name indicator for the topic within the instant message user interface of the instant message device.

44. A method for providing notification of one or more events within an instant message communication system as recited in claim 42, wherein the instant message user interface further includes a topic screen name history for each topic, the method further comprising:
in the server,
detecting the presence of a second event associated with the topic represented by the topic screen name; and
sending a notification of the presence of the second event associated with the topic; and
in at least one of the instant message devices:
displaying a first event indicator within the topic screen name history for the topic in response to receiving the notification of the presence of the first event;
receiving the notification of the presence of a second event associated with the topic; and
displaying a second event indicator within the topic screen name history for the topic in response to receiving the notification of the presence of the second event.

45. A method for providing notification of one or more events within an instant message communication system having a content server, an instant message server, and one or more instant message devices, the method comprising:
in the content server:
storing a plurality of screen names, wherein each of the plurality of screen names represents an event;
detecting the presence of an event represented by a screen name; and
establishing communication with the instant message server; and
in the instant message server:
sending an instant message to the one or more instant message devices including the screen name.

46. A method for providing notification of one or more events within an instant message communication system as recited in claim 45 further comprising:
in at least one of the instant message devices:
receiving the instant message; and
displaying an event identifier associated with the event within an instant message user interface.

47. A method for providing notification of one or more events within an instant message communication system as recited in claim 46 further comprising:
in the content server:
informing the instant message server of a participation method for participating in the event;
in the instant message server:
sending an instant message including the participation method; and
in at least one of the instant message devices:
receiving the instant message including the participation method; and
retrieving the event using the participation method.

48. A method for providing notification of one or more events within an instant message communication system having a content server, an instant message server, and one or more instant message devices, the method comprising:
in the content server:
storing a plurality of screen names, wherein each of the plurality of screen names represents an event;
detecting the presence of event information associated with an event represented by a screen name; and
establishing communication with the instant message server; and
in the instant message server:
sending an instant message to the one or more instant message devices.

49. A method for providing notification of one or more events within an instant message communication system as recited in claim 48 further comprising:
in at least one of the instant message devices:
receiving the instant message; and
displaying an event identifier associated with the event within an instant message user interface.

50. A method for providing notification of one or more events within an instant message communication system as recited in claim 49 wherein the information associated with the event received includes an event icon associated with the event.

51. A method for providing notification of one or more events within an instant message communication system having a content server, an instant message server, and one or more instant message devices, the method comprising:
in the content server:
storing a plurality of topic screen names, wherein each of the plurality of topic screen names represents a topic;
detecting the presence of at least one event associated with a topic represented by a topic screen name; and
establishing communication with the instant message server utilizing the topic screen name;
in the instant message server:
sending an instant message including the topic screen name and the event;
in at least one instant message device:
receiving the instant message; and
displaying a topic screen name indicator on an instant message user interface wherein the topic screen name indicator is associated with the topic screen name.

52. A method for providing notification of one or more events within an instant message communication system as recited in claim 51 wherein a topic screen name history is further associated with the topic screen name, the method further comprising:
displaying an event presence indicator in the topic screen name history wherein the event presence indicator is associated with the event.

53. A method for providing notification of one or more events within an instant message communication system as recited in claim 52 further comprising:
in the content server:
detecting the presence of a second event associated with the topic represented by the topic screen name;
in the instant message server:
sending a second instant message including the topic screen name and the second event;
in at least one instant message device:
receiving the second instant message; and
displaying a second event presence indicator in the topic screen name history wherein the second event presence indicator is associated with the second event.
